(19) United States
(12) Patent Application Publication
(10) Pub. No.: US 2016/0341456 A1
(43) Pub. Date: Nov. 24, 2016

(54) EVAPORATOR AND A METHOD FOR FORMING AN EVAPORATOR

(71) Applicant: General Electric Company, Schenectady, NY (US)

(72) Inventors: Michael John Kempiak, Osceola, IN (US); Brent Alden Junge, Evansville, IN (US)

(21) Appl. No.: 14/719,530

(22) Filed: May 22, 2015

(51) Int. Cl. F25B 39/02; F28D 1/047; F28F 1/36; B23P 15/26

(52) U.S. Cl. CPC F25B 39/02; B23P 15/26; F28D 1/047; F28F 1/36

(57) ABSTRACT

An evaporator includes a conduit and a spine fin assembly positioned on an outer surface of the conduit. The spine fin assembly is wound about the conduit such that a pitch between windings of the spine fin assembly varies along a length of the conduit. A related refrigerator appliance and method for forming an evaporator are also provided.

### FIELD OF THE INVENTION

The present subject matter relates generally to evaporators, such as evaporators for refrigerator appliances, and methods for forming evaporators.

### BACKGROUND OF THE INVENTION

Refrigerator appliances generally include sealed systems for cooling chilled chambers of the refrigerator appliance. During operation of the sealed system, a compressor generates compressed refrigerant. The compressed refrigerant flows to a condenser where the refrigerant is condensed into a liquid and is sent to an expansion device. The expansion device reduces a pressure of the refrigerant before the refrigerant enters into an evaporator as a combination of liquid and vapor. The refrigerant exits the evaporator as vapor and is transported to the compressor via a suction line. Refrigerant within the evaporator absorbs heat from the chilled chambers.

Various evaporators are available for use in refrigerator appliances. Certain refrigerator appliances include a spine fin evaporators. Spine fin evaporators include spine fin coils wrapped about a conduit. The spine fin coils can facilitate heat transfer between refrigerant within the conduit and ambient atmosphere within the refrigerator appliance's chilled chambers.

An efficiency of the spine fin evaporators can be improved by increasing a number of spine fins coils per unit length of conduit. However, increasing the number of spine fins coils can also result in an air side pressure drop. Thus, more energy may be required to operate an evaporator fan and achieve sufficient air flow across the spine fins. In addition, frost growth on closely positioned spine fins coils can block air flow between the spine fins over time.

Accordingly, an evaporator with features for increasing a surface area of exposed spine fins would be useful. In particular, an evaporator with features for increasing a surface area of exposed spine fins while maintaining sufficient spacing between adjacent spine fin coils would be useful.

### BRIEF DESCRIPTION OF THE INVENTION

The present subject matter provides an evaporator. The evaporator includes a conduit and a spine fin assembly positioned on an outer surface of the conduit. The spine fin assembly is wound about the conduit such that a pitch between windings of the spine fin assembly varies along a length of the conduit. A related refrigerator appliance and method for forming an evaporator are also provided. Additional aspects and advantages of the invention will be set forth in part in the following description, or may be apparent from the description, or may be learned through practice of the invention.

In a first exemplary embodiment, an evaporator is provided. The evaporator defines an axial direction, a radial direction and a circumferential direction. The evaporator includes a conduit having an outer surface. A spine fin assembly is positioned on the outer surface of the conduit. The spine fin assembly has a first plurality of spine fins and a second plurality of spine fins. The spine fin assembly is wound about the conduit such that that a pitch between windings of the spine fin assembly varies along a length of the conduit. The spine fins of the first and second pluralities of spine fins extend away from the outer surface of the conduit. A distal end portion of each spine fin of the first plurality of spine fins is positioned between distal end portions of a respective pair of spine fins of the second plurality of spine fins along the circumferential direction.

In a second exemplary embodiment, a refrigerator appliance is provided. The refrigerator appliance includes a cabinet that defines a chilled chamber. An evaporator is positioned within the cabinet adjacent the chilled chamber of the cabinet. The evaporator defines an axial direction, a radial direction and a circumferential direction. The evaporator includes a conduit having an outer surface. A spine fin assembly is positioned on the outer surface of the conduit. The conduit defines a length along the axial direction. The spine fin assembly is wound about the conduit such that a pitch between adjacent windings of the spine fin assembly varies along the length of the conduit. The pitch between adjacent windings of the spine fin assembly adjacent a bottom portion of the chilled chamber is larger than the pitch between adjacent windings of the spine fin assembly adjacent a top portion of the chilled chamber.

In a third exemplary embodiment, a method for forming an evaporator is provided. The method includes providing a sheet of material and cutting a first plurality of fins on a first side of the sheet of material and a second plurality of fins on a second side of the sheet of material. The first plurality of fins is offset from the second plurality of fins. The method also includes folding the sheet of material such that the first plurality of fins contacts the second plurality of fins and wrapping the sheet of material onto an outer surface of a conduit such that a pitch between adjacent windings of the sheet of material varies along a length of the conduit. A distal end portion of each spine fin of the first plurality of spine fins is positioned between distal end portions of a respective pair of spine fins of the second plurality of spine fins along a circumferential direction after the step of wrapping.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front elevation view of a refrigerator appliance according to an exemplary embodiment of the present subject matter.

FIG. 2 is schematic view of certain components of the exemplary refrigerator appliance of FIG. 1.

FIG. 3 provides a partial, side elevation view of an evaporator according to an exemplary embodiment of the present subject matter.

FIG. 4 provides a section view of the exemplary evaporator of FIG. 3 taken along the 4-4 line of FIG. 3.

FIG. 5 provides a partial section view of the exemplary evaporator of FIG. 4 taken along the 5-5 line of FIG. 4.

FIG. 6 provides a schematic view of the exemplary evaporator of FIG. 3.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

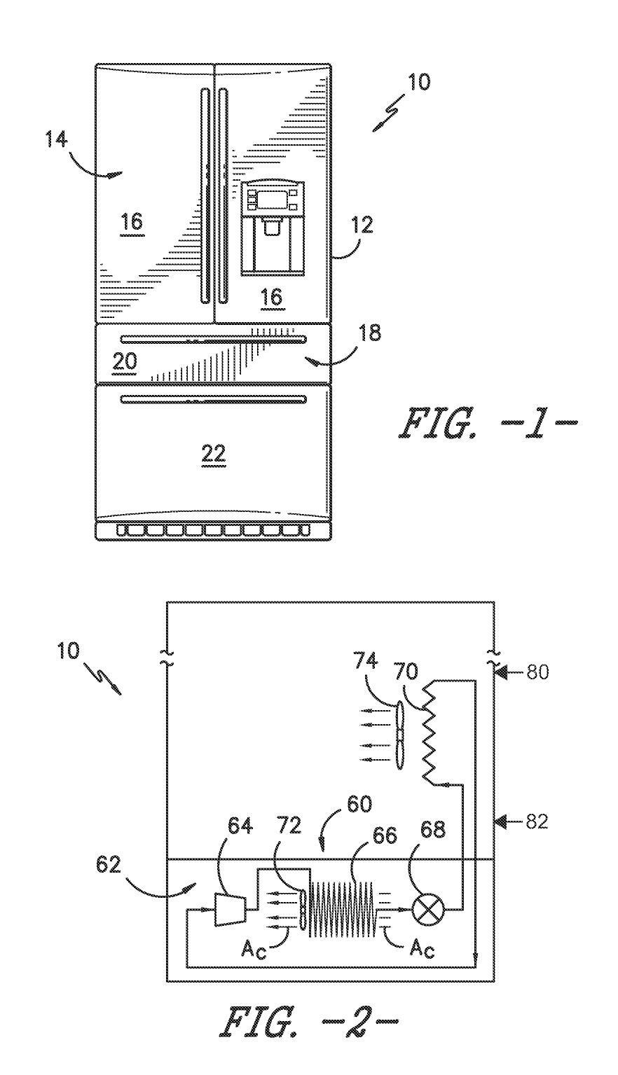

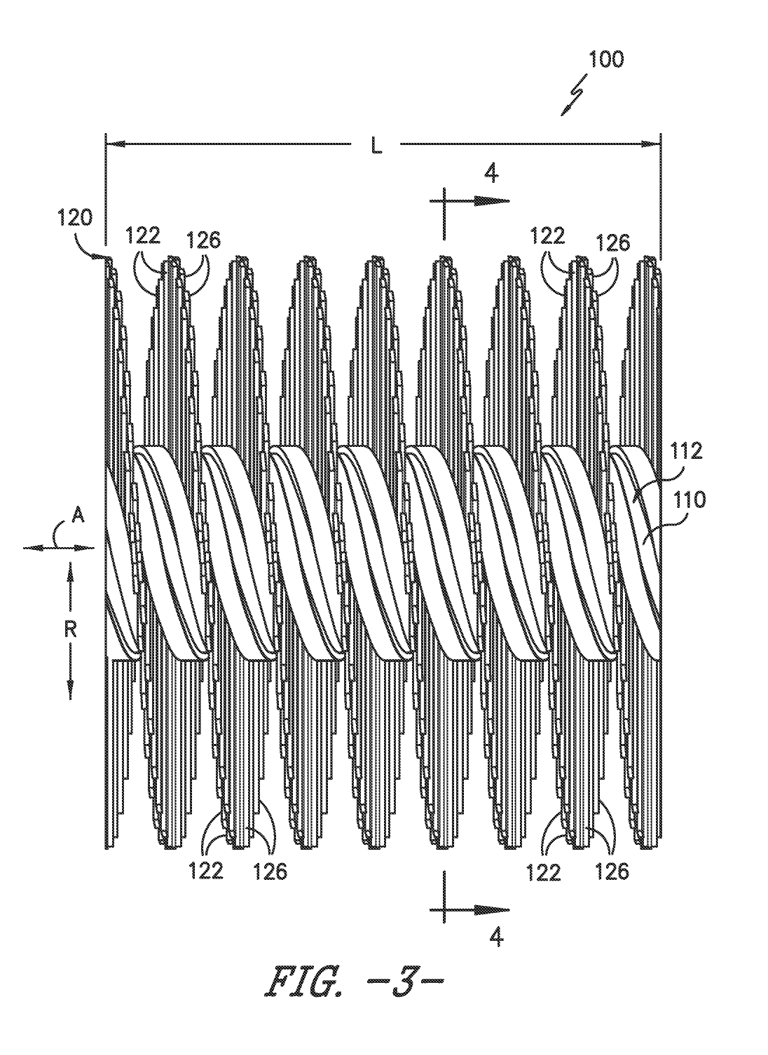

FIG. 1 depicts a refrigerator appliance 10 that incorporates a sealed refrigeration system 60 (FIG. 2). It should be appreciated that the term “refrigerator appliance” is used in a generic sense herein to encompass any manner of refrigeration appliance, such as a freezer, refrigerator/freezer combination, and any style or model of conventional refrigerator. In addition, it should be understood that the present subject matter is not limited to use in appliances. Thus, the present subject matter may be used for any other suitable purpose, such as in HVAC units.

In the exemplary embodiment shown in FIG. 1, the refrigerator appliance 10 is depicted as an upright refrigerator having a cabinet or casing 12 that defines a number of internal chilled storage compartments. In particular, refrigerator appliance 10 includes upper fresh-food compartments 14 having doors 16 and lower freezer compartment 18 having upper drawer 20 and lower drawer 22. The drawers 20 and 22 are “pull-out” drawers in that they can be manually moved into and out of the freezer compartment 18 on suitable slide mechanisms.

FIG. 2 is a schematic view of certain components of refrigerator appliance 10, including a sealed refrigeration system 60 of refrigerator appliance 10. A machinery compartment 62 contains components for executing a known vapor compression cycle for cooling air. The components include a compressor 64, a condenser 66, an expansion device 68, and an evaporator 70 connected in series and charged with a refrigerant. As will be understood by those skilled in the art, refrigeration system 60 may include additional components, e.g., at least one additional evaporator, compressor, expansion device, and/or condenser. As an example, refrigeration system 60 may include two evaporators.

Within refrigeration system 60, refrigerant flows into compressor 64, which operates to increase the pressure of the refrigerant. This compression of the refrigerant raises its temperature, which is lowered by passing the refrigerant through condenser 66. Within condenser 66, heat exchange with ambient air takes place so as to cool the refrigerant. A condenser fan 72 is used to pull air across condenser 66, as illustrated by arrows A_{C}, so as to provide forced convection for a more rapid and efficient heat exchange between the refrigerant within condenser 66 and the ambient air. Thus, as will be understood by those skilled in the art, increasing air flow across condenser 66 can, e.g., increase the efficiency of condenser 66 by improving cooling of the refrigerant contained therein.

An expansion device (e.g., a valve, capillary tube, or other restriction device) 68 receives refrigerant from condenser 66. From expansion device 68, the refrigerant enters evaporator 70. Upon exiting expansion device 68 and entering evaporator 70, the refrigerant drops in pressure. Due to the pressure drop and/or phase change of the refrigerant, evaporator 70 is cool relative to compartments 14 and 18 of refrigerator appliance 10. As such, cooled air is produced and refrigerates compartments 14 and 18 of refrigerator appliance 10. Thus, evaporator 70 is a type of heat exchanger which transfers heat from air passing over evaporator 70 to refrigerant flowing through evaporator 70. An evaporator fan 74 is used to pull air across evaporator 70 and circulate air within compartments 14 and 18 of refrigerator appliance 10.

Collectively, the vapor compression cycle components in a refrigeration circuit, associated fans, and associated compartments are sometimes referred to as a sealed refrigeration system operable to force cold air through compartments 14, 18 (FIG. 1). The refrigeration system 60 depicted in FIG. 2 is provided by way of example only. Thus, it is within the scope of the present subject matter for other configurations of the refrigeration system to be used as well.

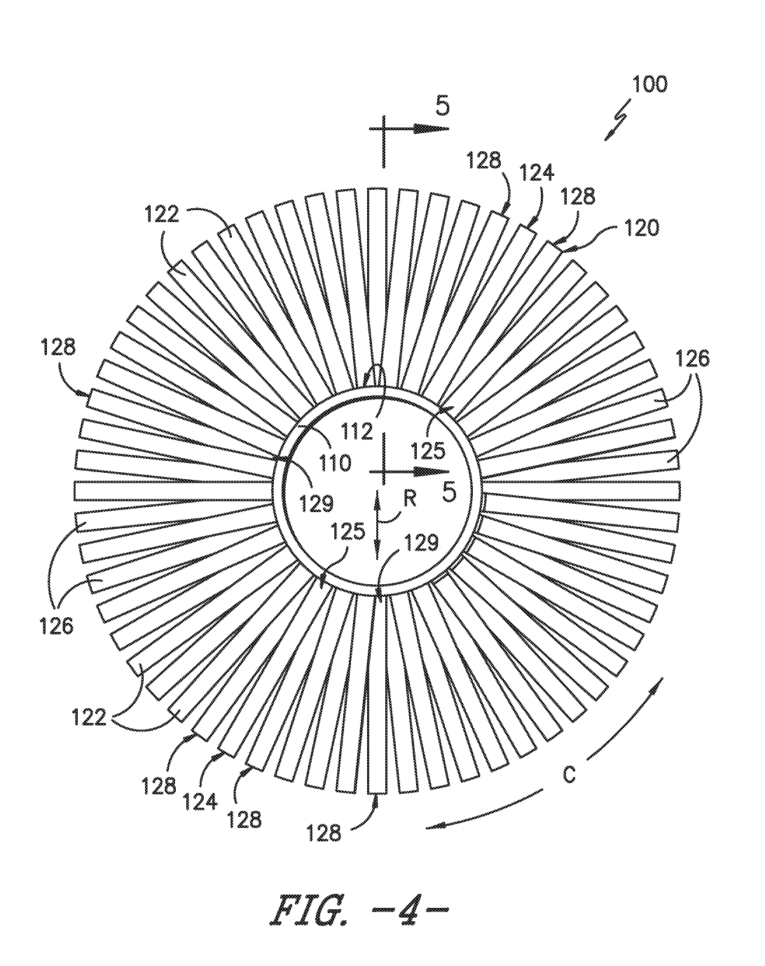

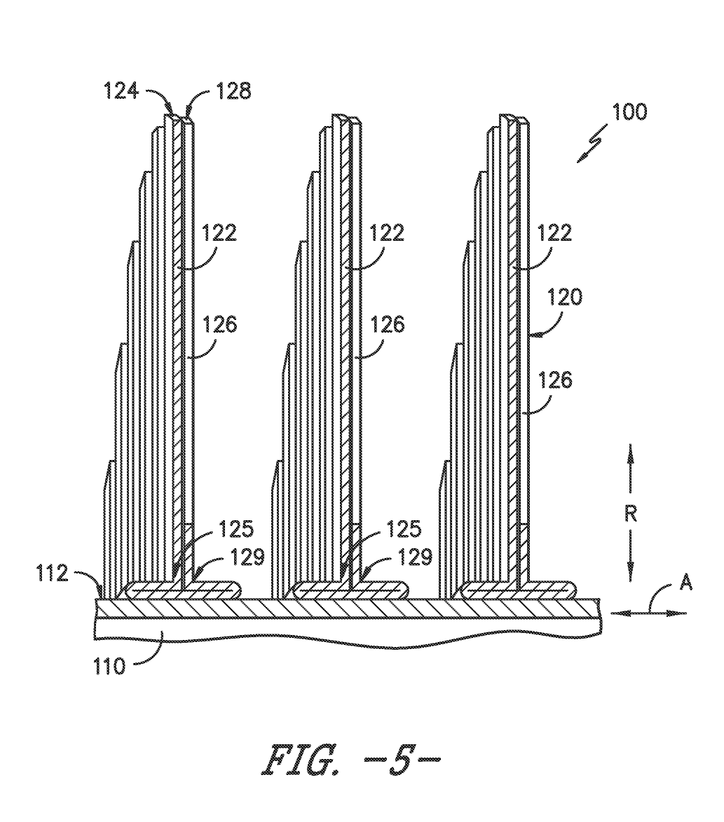

FIG. 3 provides a partial, side elevation view of an evaporator 100 according to an exemplary embodiment of the present subject matter. FIG. 4 provides a section view of evaporator 100 taken along the 4-4 line of FIG. 3. Evaporator 100 may be used in any suitable refrigeration system or HVAC system. As an example, evaporator 100 may be used in refrigeration system 60 of refrigerator appliance 10 (FIG. 2). Evaporator 100 includes features for improving performance of an associated refrigeration system or HVAC system. Evaporator 100 may be constructed or assembled in a similar manner to the evaporator described in U.S. patent application Ser. No. 14/248,608 of Michael John Kempiak entitled “An Evaporator and a Method for Forming an Evaporator,” which is hereby incorporated by reference for all purposes.

As may be seen in FIGS. 3 and 4, evaporator 100 defines an axial direction A, a radial direction R and a circumferential direction C. Evaporator 100 includes a conduit 110. Conduit 110 is configured for containing a refrigerant therein and directing a flow of refrigerant therethrough. Conduit 110 has an outer surface 112. Conduit 110 may be constructed of or with any suitable material. As an example, conduit 110 may be constructed of or with a metal, such as copper tubing or aluminum tubing. Conduit 110 may also have any suitable cross-sectional shape. For example, conduit 110 may have a circular cross-section, e.g., in a plane that is perpendicular to the axial direction A. In certain exemplary embodiments, conduit 110 may be a single piece of tubing, such as copper tubing or aluminum tubing, bend or otherwise plastically deformed into a serpentine or curved pattern, as shown in FIG. 6.

Evaporator 100 also includes a spine fin assembly 120. Spine fin assembly 120 is disposed or positioned on or at outer surface 112 of conduit 110. In particular, spine fin assembly 120 is wrapped about conduit 110 such that spine fin assembly 120 is mounted to conduit 110 at outer surface 112 of conduit 110. Thus, spine fin assembly 120 may have a helical shape, e.g., when wound about conduit 110. Spine fin assembly 120 includes a plurality of first spine fins 122 and a plurality of second spine fins 126. First spine fins 122 and second spine fins 126 are wound about conduit 110, e.g., such that first spine fins 122 are spaced apart from one another along the circumferential direction C and second spine fins 126 are spaced apart from one another along the circumferential direction C within each winding of spine fin assembly 120.

Spine fin assembly 120 may be constructed of or with any suitable material. As an example, spine fin assembly 120 may be constructed of or with a metal, such as copper or aluminum. In particular, spine fin assembly 120 may be constructed of or with a continuous sheet of material, such as a sheet of aluminum or copper. Thus, first spine fins 122 and second spine fins 126 may be defined by or formed with the continuous sheet of material.

Turning now to FIG. 4, first spine fins 122 and second spine fins 126 extend away from outer surface 112 of conduit 110, e.g., along the radial direction R. In particular, a distal end portion 124 of each spine fin of first spine fins 122 is positioned between distal end portions 128 of a respective pair of spine fins of second spine fins 126, e.g., along the circumferential direction C. In particular, distal end portion 124 of each spine fin of first spine fins 122 may be positioned about equidistant from distal end portions 128 of the respective pair of spine fins of second spine fins 126, e.g., along the circumferential direction C. Thus, first spine fins 122 and second spine fins 126 are offset from each other, e.g., along the circumferential direction C. By offsetting first spine fins 122 and second spine fins 126, an exposed surface area of each winding of spine fin assembly 120 may be increased and a an efficiency of an associated appliance may be improved, e.g., without dramatically increasing an air side pressure drop across evaporator 100.

As may be seen in FIG. 3, conduit 110 defines a length L, e.g., along the axial direction A. First spine fins 122 and second spine fins 126 are wound about conduit 110 along the length L of conduit 110. First spine fins 122 and second spine fins 126 may be wound at any suitable rate along the length L of conduit 110. For example, first spine fins 122 and second spine fins 126 may be wound about conduit 110 at a rate of about nine windings per inch of conduit 110 along the length L of conduit 110. As another example, first spine fins 122 and second spine fins 126 may be wound about conduit 110 at a rate of greater than seven windings per inch of conduit 110 along the length L of conduit 110 and less than eleven windings per inch of conduit 110 along the length L of conduit 110. As yet another example, first spine fins 122 and second spine fins 126 may be wound about conduit 110 at a rate of greater than five windings per inch of conduit 110 along the length L of conduit 110 and less than twelve windings per inch of conduit 110 along the length L of conduit 110.

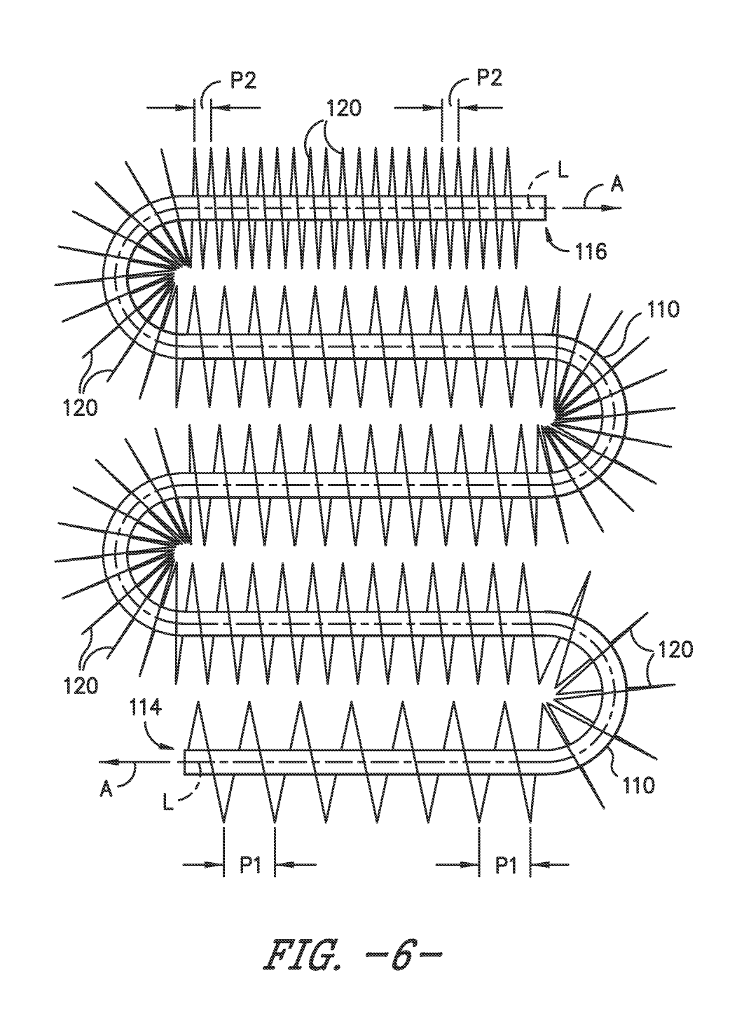

FIG. 5 provides a partial section view of evaporator 100 taken along the 5-5 line of FIG. 4. As may be seen in FIG. 5, first spine fins 122 and second spine fins 126 are wound about conduit 110 such that each winding of first spine fins 122 is positioned adjacent a respective winding of second spine fins 126. Thus, first spine fins 122 and second spine fins 126 may wound about conduit 110 in a double helical manner with each winding of first spine fins 122 positioned adjacent the respective winding of second spine fins 126. In particular, a proximal end portion 125 of each spine fin of first spine fins 122 is positioned at or adjacent proximal end portions 129 of the respective pair of spine fins of second spine fins 126. For example, the proximal end portion 125 of each spine fin of first spine fins 122 may contact proximal end portions 129 of the respective pair of spine fins of second spine fins 126. Thus, spine fins of first spine fins 122 contact spine fins of second spine fins 126, e.g., at or adjacent conduit 110.

Spine fin assembly 120 may be formed in any suitable manner. For example, a sheet of material may be provided. The sheet of material may be any suitable material. For example, sheet of material may be a metal, such as copper or aluminum. The sheet of material has a first side portion and a second side portion positioned opposite each other on the sheet of material. The sheet of material is then cut. In particular, the sheet of material is cut such that a set of first spine fins is cut at first side portion of the sheet of material and a set of second spine fins is cut at second side portion of the sheet of material. The sheet of material is also cut such that first spine fins are offset from second spine fins. For example, each cut at the first side portion of the sheet of material may be between a respective pair of cuts at the second side portion of the sheet of material.

The sheet of material is folded at a first set of folds, e.g., such that the first spine fins are spaced apart from the second spine fins. The sheet of material is folded again at a second set of folds, e.g., such that the first spine fins are positioned adjacent (e.g., contact) the second spine fins. The spine fin assembly is thus formed and may be wrapped about a conduit to assemble an evaporator. For example, turning back to FIG. 3, the spine fin assembly may be wrapped onto outer surface 112 of conduit 110 in order to form evaporator 100.

FIG. 6 provides a schematic view of evaporator 100. As may be seen in FIG. 6, spine fin assembly 120 is wound about conduit 110 such that a pitch between windings of spine fin assembly 120 (e.g., along the axial direction A) varies along the length L of conduit 110. For example, conduit 110 extends between a first end portion 114 and a second end portion 116, e.g., along the axial direction A. As shown in FIG. 6, conduit 110 may be bent into a serpentine shape and/or curved shape such that the axial direction A is curved and not completely rectilinear in certain exemplary embodiments. Windings of spine fin assembly 120 at or adjacent first end portion 114 of conduit 110 may be spaced apart or separated at a first pitch P1, and windings of spine fin assembly 120 at or adjacent second end portion 116 of conduit 110 may be spaced apart or separated at a second pitch P2. The first pitch P1 may be greater than the second pitch P2. Thus, windings of spine fin assembly 120 at or adjacent second end portion 116 of conduit 110 may be closer together than windings of spine fin assembly 120 at or adjacent first end portion 114 of conduit 110. In addition, as may be seen in FIG. 6, the windings of spine fin assembly 120 between first and second end portions 114, 116 of conduit 110 may be spaced apart or separated at a pitch (or pitches) different than the first and second pitches P1, P2.

The pitch between windings of spine fin assembly 120 on conduit 110 may vary in any suitable manner along the length L of conduit 110. For example, windings of spine fin assembly 120 on each rectilinear portion of conduit 110 may be uniformly spaced, and the pitch between windings of spine fin assembly 120 may change between rectilinear portions of conduit 110, as shown in FIG. 6. In alternative exemplary embodiments, the pitch between windings of spine fin assembly 120 on rectilinear portions of conduit 110 may also vary.

Varying the pitch between windings of spine fin assembly 120 on conduit 110 may assist with improving performance of evaporator 100. For example, an airflow distribution pattern across evaporator 100 may more uniform relative to evaporators with constant pitch windings. In addition, the frost holding capacity of evaporator 100 may be increased relative to evaporators with constant pitch windings by providing low spline density at high frost areas and high spline density away from the high frost areas.

As an example, windings of spine fin assembly 120 at the first pitch P1 may be positioned at or adjacent a bottom portion 82 (FIG. 2) of a chilled chamber of refrigerator appliance 10, and windings of spine fin assembly 120 at the second pitch P2 may be positioned at or adjacent a top portion 80 (FIG. 2) of the chilled chamber of refrigerator appliance 10. Thus, evaporator 100 may have a higher spline density at or adjacent top portion 80 of the chilled chamber relative to the bottom portion 82 of the chilled chamber. In such a manner, frost build up at an inlet of evaporator 100 may be limited or reduced. In particular, by varying the pitch between windings of spine fin assembly 120 on conduit 110 such that the air inlet location has larger spaces between adjacent windings of spine fin assembly 120 and decreasing the pitch between windings of spine fin assembly 120 on conduit 110 along the airflow path on evaporator 100, evaporator 100 may be more tolerant to frost buildup.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An evaporator defining an axial direction, a radial direction and a circumferential direction, the evaporator comprising:
a conduit having an outer surface;
a spine fin assembly positioned on the outer surface of the conduit, the spine fin assembly having a first plurality of spine fins and a second plurality of spine fins, the spine fin assembly wound about the conduit such that a pitch between windings of the spine fin assembly varies along a length of the conduit, the spine fins of the first and second pluralities of spine fins extending away from the outer surface of the conduit, a distal end portion of each spine fin of the first plurality of spine fins positioned between distal end portions of a respective pair of spine fins of the second plurality of spine fins along the circumferential direction.

2. The evaporator of claim 1, wherein a proximal end portion of each spine fin of the first plurality of spine fins is positioned adjacent proximal end portions of the respective pair of spine fins of the second plurality of spine fins.

3. The evaporator of claim 2, wherein the proximal end portion of each spine fin of the first plurality of spine fins contacts the proximal end portions of the respective pair of spine fins of the second plurality of spine fins.

4. The evaporator of claim 1, wherein the conduit extends between a first end portion and a second end portion along the axial direction, the pitch between windings of the spine fin assembly at the first end portion of the conduit being greater than the pitch between windings of the spine fin assembly at the second end portion of the conduit.

5. The evaporator of claim 4, wherein the spine fin assembly is wound about the conduit at a rate of at least four windings per inch of conduit and at most than twelve windings per inch of conduit adjacent the second end portion of the conduit.

6. The evaporator of claim 1, wherein the conduit is bent into a serpentine pattern and the first and second pluralities of spine fins are defined by a continuous sheet of material.

7. The evaporator of claim 1, wherein the distal end portion of each spine fin of the first plurality of spine fins is positioned about equidistant from the distal end portions of the respective pair of spine fins of the second plurality of spine fins along the circumferential direction.

8. A refrigerator appliance, comprising:
a cabinet that defines a chilled chamber; and
an evaporator positioned within the cabinet adjacent the chilled chamber of the cabinet, the evaporator defining an axial direction, a radial direction and a circumferential direction, the evaporator comprising
a conduit having an outer surface; and
a spine fin assembly positioned on the outer surface of the conduit, the conduit defining a length along the axial direction, the spine fin assembly wound about the conduit such that a pitch between adjacent windings of the spine fin assembly varies along the length of the conduit, the pitch between adjacent windings of the spine fin assembly adjacent a bottom portion of the chilled chamber being larger than the pitch between adjacent windings of the spine fin assembly adjacent a top portion of the chilled chamber.

9. The refrigerator appliance of claim 8, wherein the spine fin assembly having a first plurality of spine fins and a second plurality of spine fins, the first and second pluralities of spine fins wound about the conduit such that each winding of the first plurality of spine fins is positioned adjacent a respective winding of the second plurality of spine fins, spine fins of the first and second pluralities of spine fins extending away from the outer surface of the conduit such that each spine fin of the first plurality of spine fins is positioned between a respective pair of spine fins of the second plurality of spine fins along the circumferential direction.

10. The refrigerator appliance of claim 9, wherein the spine fins of the first plurality of spine fins contact the spine fins of the second plurality of spine fins near the conduit.

11. The refrigerator appliance of claim 9, wherein the conduit is bent into a serpentine pattern and the first and second pluralities of spine fins are defined by a continuous sheet of material.

12. The refrigerator appliance of claim 9, wherein each spine fin of the first plurality of spines fin is positioned about equidistant from the respective pair of spine fins of the second plurality of spine fins along the circumferential direction.

13. The refrigerator appliance of claim 8, wherein the conduit extends between a first end portion and a second end portion along the axial direction, the pitch between windings of the spine fin assembly at the first end portion of the conduit being greater than the pitch between windings of the spine fin assembly at the second end portion of the conduit.

14. The refrigerator appliance of claim 13, wherein the spine fin assembly is wound about the conduit at a rate of at least four windings per inch of conduit and at most twelve windings per inch of conduit at the second end portion of the conduit.

15. A method for forming an evaporator, comprising:
providing a sheet of material;
cutting a first plurality of fins on a first side of the sheet of material and a second plurality of fins on a second side of the sheet of material, the first plurality of fins being offset from the second plurality of fins;
folding the sheet of material such that the first plurality of fins contacts the second plurality of fins;
wrapping the sheet of material onto an outer surface of a conduit such that a pitch between adjacent windings of the sheet of material varies along a length of the conduit,
wherein a distal end portion of each spine fin of the first plurality of spine fins is positioned between distal end portions of a respective pair of spine fins of the second plurality of spine fins along a circumferential direction after said step of wrapping.

16. The method of claim 15, wherein said step of wrapping comprises wrapping the sheet of material onto the outer surface of the conduit at a rate of at least four windings per inch of conduit along the length of the conduit and at most twelve windings per inch of conduit along the length of the conduit.

17. The method of claim 15, wherein the first side portion of the sheet of material is positioned opposite the second side portion of the sheet of material.

18. The method of claim 15, wherein the material comprises aluminum.

19. The method of claim 15, wherein said step of folding comprises folding the sheet of material such that the first plurality of fins contacts the second plurality of fins along respective heights of the first and second pluralities of fins.
